(19) United States
(12) Patent Application Publication
(10) Pub. No.: US 2026/0159259 A1
(43) Pub. Date: Jun. 11, 2026

(54) AUTONOMOUS PRECISION LANDING MAT FOR AERIAL DRONES

(71) Applicant: Elzee Technologies Inc., North Potomac, MD (US)

(72) Inventor: Shubber ALI, North Potomac, MD (US)

(21) Appl. No.: 19/413,627

(22) Filed: Dec. 9, 2025

Related U.S. Application Data
(60) Provisional application No. 63/730,293, filed on Dec. 10, 2024.

(51) Int. Cl. B64U 70/92; B64U 20/80; B64U 50/37; B64U 70/95; B64U 70/97; B64U 101/64; G05D 1/243; G05D 1/247; G05D 1/654; G05D 1/667; G05D 105/28; G05D 109/20; G05D 111/10; G05D 111/30; G06T 7/73; H04N 7/18

(52) U.S. Cl. CPC B64U 70/92; B64U 20/80; B64U 50/37; B64U 70/95; B64U 70/97; G05D 1/243; G05D 1/247; G05D 1/654; G05D 1/667; G06T 7/73; H04N 7/183; B64U 2101/64; B64U 2201/104; G05D 2105/285; G05D 2109/20; G05D 2111/10; G05D 2111/32; G06T 2207/10032

(57) ABSTRACT

Disclosed herein are system, method, and computer program product embodiments for providing autonomous precision landing and delivery for aerial drones. An aerial drone may travel to a geographic coordinate. At the geographic coordinate, a user may place a landing mat for delivery. The landing mat may include antennas that transmit long range (LoRa) radio signals used by an aerial drone to control spatial positioning. The aerial drone may receive the LoRa radio signals and detect respective phase values. The aerial drone may adjust its spatial position to align the phase values and align itself above the landing mat. The aerial drone may then use a camera to capture images of a visual code on the landing mat for fine-grain positioning. Using the LoRa radio signals and the images of the visual code, the aerial drone may perform precise landing and delivery to the landing mat.

### CROSS-REFERENCE TO RELATED APPLICATIONS

This application claims benefit of and priority to U.S. Application No. 63/730,293, filed Dec. 10, 2024, which is hereby incorporated by reference in its entirety.

### BACKGROUND

### Technical Field

One or more implementations relate to the field of autonomous precision landing and delivery reporting for aerial drones.

### Background Art

Attempts at using aerial drones for delivery have been burdensome and have not been widely adopted. Due to a lack of precision in delivery, current regulations require such deliveries to be performed by certified pilots. Using pilots to individually navigate aerial drones, however, limits scalability and prevents widespread adoption. While the issues with precision delivery are problematic for residential deliveries, the lack of precise landing is especially problematic for other locations as well. For example, deliveries to remote locations, such as forests, deserts, or onto boats at sea are difficult without precision landing. This lack of precision is also an issue where the landing location is moving, such as when the delivery is to a moving ship at sea. There are also problems with precision landing in high conflict areas such as in military zones or when first responders are addressing emergency situations in hazardous environments. There are currently also issues with providing deliveries to high rise apartments with balconies that may accept packages via drone delivery. In this manner, a lack of precise delivery and landing prevents scalability and access to other locations for delivery. In addition to these issues, there are also difficulties in validating and verifying delivery to these locations as well as tracking potential carbon savings for aerial drone deliveries.

### BRIEF DESCRIPTION OF THE DRAWINGS

The accompanying drawings are incorporated herein and form a part of the specification.

FIG. 1 depicts a block diagram of an aerial drone delivery environment, according to some embodiments.

FIG. 2 depicts a diagram of a landing mat, according to some embodiments.

FIG. 3A depicts a flowchart illustrating a method for autonomously operating an aerial drone for delivery, according to some embodiments.

FIG. 3B depicts a flowchart illustrating a method for adjusting a spatial position of an aerial drone using a detected phase values, according to some embodiments.

FIG. 4 depicts a flowchart illustrating a method for operating a landing mat for delivery, according to some embodiments.

FIG. 5 depicts a flowchart illustrating a method for scheduling an aerial drone delivery, according to some embodiments.

FIG. 6 depicts a flowchart illustrating a method for calculating a carbon credit, according to some embodiments.

FIG. 7 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for autonomous precision landing and delivery reporting for aerial drones.

In some embodiments, a precision landing mat provides precise autonomous landing control, portability in deployment, and/or delivery verification for aerial drone deliveries. To provide precise landing control, the landing mat may include one or more antennas and/or a visual code. The one or more antennas may transmit long range (LoRa) radio signals used by an aerial drone to control positioning. For example, the aerial drone may receive the LoRa radio signals for control of its rotors and blades for positioning. In some embodiments, the aerial drone may control its positioning to align the received phase for the LoRa radio signals. For example, the aerial drone may utilize a feedback process to adjust positioning so that the received LoRa radio signals are detected as having the same phase. In some embodiments, the aerial drone may use a trilateration process to perform this positioning. By aligning the phase of the detected LoRa radio signals, the aerial drone may precisely position itself above the landing mat. This position may be a desired and/or a centered position above the landing mat. Based on this positioning, the aerial drone may be lowered to land on the landing mat to provide delivery.

To provide delivery, the aerial drone may be configured to travel to a geographic coordinate. For example, the geographic coordinate may indicate a residential address and/or a non-residential coordinate. In some embodiments, the geographic coordinate may be a coordinate associated with a satellite service such as, for example, a Global Positioning System (GPS) coordinate or a Global Navigation Satellite System (GNSS) coordinate. The aerial drone may then autonomously travel to the specified geographic coordinate. When the aerial drone nears the specified geographic coordinate, the aerial drone may detect the LoRa radio signals transmitted from the landing mat. The aerial drone may then position itself above the landing mat such that the phases of the LoRa radio signals match. Upon positioning the aerial drone to align the phase values, the aerial drone may then use a camera on the aerial drone to further aid with precision landing.

The camera may capture one or more images and/or video of a visual code on the landing mat. For example, the visual code may be a printed design on the landing mat. In another example, the visual code may be a dynamic design generated by a display on the landing mat. The display may be configured to dynamically adjust the dynamic design of the visual code. In this example, the dynamic design may be within the visible spectrum or may be outside the visible spectrum (e.g., infrared light). The display may be a display screen such as, for example, an active-matrix liquid crystal display (AMLCD), a passive-matrix liquid crystal display (AMLCD), a light-emitting diode (LED) display, a quantum dot light-emitting diode (QLED) display, an organic light-emitting diode (OLED) display, an E Ink electronic paper display (EPD), or the like. The display may be an array of light sources such as, for example, light-emitting diodes, light bulbs, or the like. In some embodiments, the visual code may include a matrix code or a quick response (QR) code.

The aerial drone may employ image processing and/or computer vision techniques to process the visual code to provide additional precise positioning. For example, the aerial drone may employ image processing to ensure that the visual code is located at a particular position within a captured image. In some embodiments, this may be in the center of the captured image. The aerial drone may use the image processing as an additional feedback mechanism for precise positioning. For example, if the aerial drone detects that the visual code is not located at the designated position in the image, the aerial drone may re-position itself such that a subsequently captured image includes the visual code at the designated position. Using the captured images, the aerial drone may account for position fluctuations during descent. For example, the drone may account for a breeze or other air current that moves the drone during descent. Using the captured images, the drone may re-position itself to account for such movement.

In some embodiments, the aerial drone may switch to using the camera data after positioning using the LoRa radio signals. For example, the aerial drone may position itself above the landing mat using the LoRa radio signals and then use one or more images of the visual code to provide fine-grain control for descent. In some embodiments, the LoRa radio signals may be used together with the images of the visual code during descent to provide precise landing.

After descending and/or landing on the landing mat, the aerial drone may release a carried package. This release may complete a delivery scheduled to the particular geographic coordinate. In some embodiments, the aerial drone may capture an image of the package as delivered on the landing mat. For example, this image may be used to verify completion of the delivery. In some embodiments, the landing mat may include a camera that captures the image of the package. The aerial drone and/or the landing mat may transmit the captured image to a server scheduling and/or managing the delivery to verify completion of the delivery.

To address different environments for delivery, the landing mat may be portable and/or operate in a low power mode. For example, the landing mat may include one or more power sources. The landing mat may operate in a wired mode receiving AC power and/or may be battery operated for portable deployment. To conserve energy, the landing mat may operate in a low power mode. In the low power mode, the landing mat may be scheduled to transmit the LoRa radio signals. This may occur instead of continuously transmitting the LoRa radio signals. For example, the landing mat may be configured to power on and/or power on a communication infrastructure at a particular delivery time.

To operate in this low power mode, the landing mat may receive a message and/or instruction from a server managing the delivery. For example, the server may schedule a delivery for a particular date and/or time. The server may then transmit the message and/or instruction to the landing mat to inform the landing mat of the designated date and/or time. This may be a wireless transmission. For example, the server may transmit a command to a residential router which may then deliver the date and/or time to the landing mat via a wireless Wi-Fi connection. In some embodiments, the landing mat may include a Subscriber Identification Module (SIM) card. This may be useful in environments where a Wi-Fi and/or router connection is not available. In this case, the server may deliver the designated date and/or time to the landing mat via cellular communications via the SIM card and/or other telephony communications. In some embodiments, the server may communicate the delivery information to the landing mat via satellite communications.

When operating in this low power mode, a user may place the landing mat at the geographic coordinate for delivery. In some embodiments, the landing mat may be coupled to an embedded navigation device or an external navigation device that is configured to automatically retrieve a position of the landing mat. For example, the landing mat may be configured to automatically obtain its own geographic coordinates from a satellite service such as, for example, a Global Positioning System (GPS) coordinate or a Global Navigation Satellite System (GNSS) coordinate. In this configuration, the landing mat may be able to obtain the geographic coordinates with an accuracy of about 300 meters away from the landing mat. In another example, the landing may be configured to automatically obtain an address of its location based on geographic coordinates from a satellite service. In some embodiments, the landing mat may be manually configured upon receipt of a user input indicating geographic coordinates or an address of the landing mat. Accordingly, the landing mat may use position information (obtained automatically or by user input) to establish a frame of reference for the delivery.

The landing mat may be provided with the date and/or time of delivery prior to or after the user has placed the landing mat. The landing mat may manage an internal clock and/or calendar application to detect the specified date and/or time of delivery. The landing mat may wake and/or exit the lower power mode at this time and/or before the time of delivery. The landing mat may then transmit the LoRa radio signals used by the aerial drone for positioning. In some embodiments, the landing mat may detect the completion of the delivery and/or capture an image of the delivered package. For example, this may be timing based. The landing mat may be configured to capture an image at a specified time. In some embodiments, the landing mat may be configured to use image processing to detect completion of delivery. The landing mat may also use a sensor such as a weight sensor and/or a line of sight sensor to detect the presence of a package. In some embodiments, the aerial drone may transmit a wireless signal to the landing mat to signal delivery of the package. The landing mat may capture an image in response to one or more sensors detecting the presence of a package and/or the signal transmitted by the aerial drone.

After capture, the landing mat may transmit the image to the server scheduling the delivery. The landing mat may perform this transmission via one or more of the previously discussed communication methods. This may include via a Wi-Fi and/or router connection, via cellular communications, and/or via satellite communications. The server may store the image in a database and/or update an entry in the database indicating that the delivery has been completed. In some embodiments, the server may also provide a notification to a user requesting the delivery to inform the user that the delivery has been completed.

The server may also track carbon savings via the use of the aerial drone and the landing mat. For example, if an organization uses a fleet of aerial drones with customers who are using respective landing mats for deliveries, there are carbon savings associated with the avoidance of using land vehicles to make the deliveries. That is, there is a reduction in carbon emissions when the aerial drone and landing mat are used for the delivery. The server managing the aerial drone deliveries may track such savings. For example, the server may track the distance that a truck would have needed to travel to make a delivery and/or return to a delivery hub. In some embodiments, the server may also track the time saved as a reduction in carbon emissions. With these metrics, the server may calculate an amount of carbon emissions saved for a fleet of aerial drones and/or provide such metrics to organizations using the aerial drones. For example, this may be reported as a carbon credit value.

In this manner, the aerial drone and landing mat may be deployed in various environments to provide precision deliveries. For example, a user may place the landing mat at various places around a home for delivery. These may be safe places that may be obscured from view to avoid package theft. For example, there may be a particular porch, balcony, and/or other location at a home where a user would like to receive the package. The portability of the landing mat may allow the user to select such a location. If a user lives in a high rise apartment, the user may place the landing mat on a balcony, which may be reached by the aerial drone for delivery.

In remote locations, such as forests, deserts, or onto boats at sea, the landing mat may also provide a portable way to designate a landing area. The landing mat may also provide precision landing for autonomous aerial drones as well. The landing mat may also address the scenario where the landing location is moving, such as when the delivery is on a moving ship at sea. For example, a camera on the aerial drone may use the LoRa radio signals and/or the visual code on the landing mat to align its descent. The landing mat may also be deployed in a portable manner in high conflict areas such as in military zones or when first responders are addressing emergency situations in hazardous environments. Autonomous aerial drones may use the portable landing mat to provide supplies and/or packages to such areas. The autonomous aerial drones and the landing mat may also provide scalability based on the precision landing. This may avoid the need for a certified pilot to control the navigation and/or landing of the aerial drone.

The above-mentioned embodiments can enable design options for the landing mat that may be suited for particular uses. For example, a home user may use an embodiment of the landing mat that has a printed visual code and does not automatically obtain geographic coordinates. In this example, the landing mat may provide basic features in order to offer a low cost that is accessible to an ordinary home user. In another example, a military base may use an embodiment of the landing mat that has a dynamic design visual code and automatically obtain geographic coordinates. In this example, the landing mat may provide sophisticated features that are suited to an environment in which an accurate delivery is critical. As a result, various embodiments of the landing mat may include some features and exclude other features to suit the intended use of the landing mat for a certain environment.

Various embodiments of these features will now be discussed with respect to the corresponding figures.

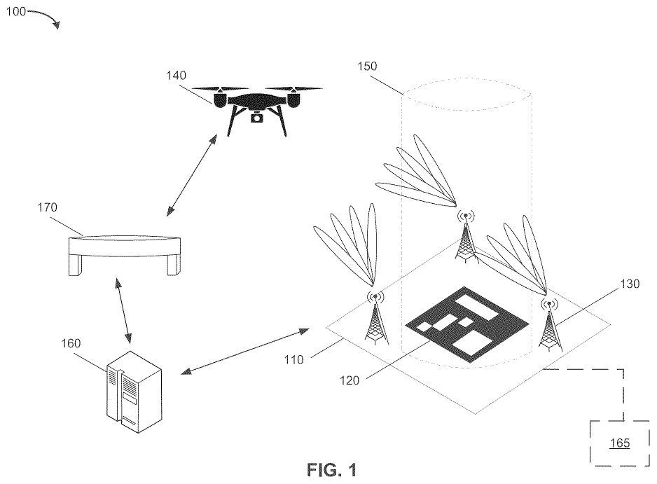

FIG. 1 depicts a block diagram of an aerial drone delivery environment 100, according to some embodiments. Aerial drone delivery environment 100 may include landing mat 110, aerial drone 140, server system 160, and/or base station 170. Landing mat 110 may include a visual code 120 and/or antennas 130. Antennas 130 may transmit and/or broadcast LoRa radio signals. The LoRa radio signals may provide a landing region 150 where the phases of LoRa radio signals received by aerial drone 140 are aligned. Landing region 150 may include a region where the phases match and/or where the difference between the phases fall within a specified threshold. When the difference between the phases fall within the specified threshold, this may reflect an acceptable positioning of aerial drone 140 above landing mat 110 such that aerial drone 140 may descend.

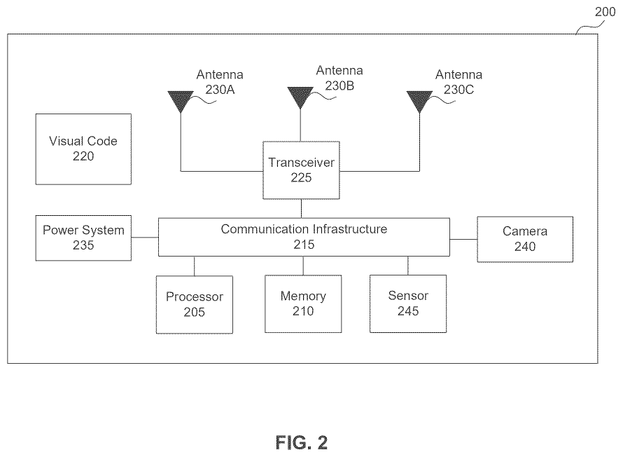

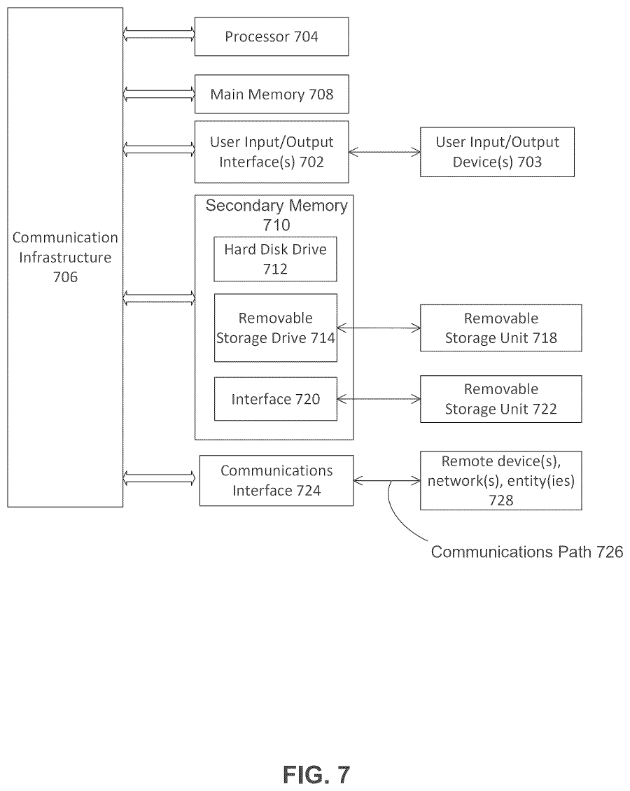

As further described with reference to FIG. 2, landing mat 110 may include one or more antennas 130, transceivers, processors, memory, and/or power systems to provide precision landing for aerial drone 140. In some embodiments, landing mat 110 may receive a designated delivery date and/or time from server system 160. Server system 160 may include one or more servers and/or databases configured to manage aerial drone deliveries. In some embodiments, server system 160 may be implemented using computer system 700 as further described with reference to FIG. 7.

In some embodiments, server system 160 may manage a fleet of aerial drones 140. Server system 160 may receive a designated aerial drone delivery for a user. In some embodiments, this delivery may correspond to an online commerce transaction. For example, server system 160 may include and/or may communicate with an online retailer to provide aerial drone delivery services. Server system 160 may receive a designated date and/or time from the online retailer. In some embodiments, server system 160 may determine the date and/or time of delivery. For example, this may be determined based on fleet availability and/or a previously designated schedule of deliveries. In some embodiments, a user may specify the date and time of delivery. Server system 160 may provide the user with available dates and/or times and the user may provide a selection.

Server system 160 may also determine a geographic coordinate for the delivery. In some embodiments, a navigation device 165 may be a device embedded within landing mat 110 or an external device coupled to landing mat 110 such that navigation device 165 may automatically obtain a geographic coordinate or an address of landing mat 110 from a satellite service. In these embodiments, navigation device 165 may provide the geographic coordinate or the address of landing mat 110 to server system 160. Navigation device 165 may be an optional component connected to landing mat 110, so some embodiments may not include navigation device 165. In some embodiments, the user and/or online retailer may provide the geographic coordinate. For example, a user may specify an address such as a home or business address for delivery. In some embodiments, the user may specify a GPS coordinate and/or a longitude or latitude coordinate for delivery. In some embodiments, server system 160 may maintain a database of user accounts with corresponding addresses and/or geographic coordinates. The user may select the geographic coordinate corresponding to the user account. In some embodiments, server system 160 may maintain landing mat 110 identifications with corresponding geographic coordinates. For example, the user may provide and/or select a particular landing mat 110 based on its identification. Server system 160 may then identify a geographic coordinate associated with the landing mat 110 identification for the delivery.

Upon determining the geographic coordinate and/or the particular corresponding landing mat 110, server system 160 may inform landing mat 110 of the delivery date and/or time. Server system 160 may transmit a message and/or an instruction to landing mat 110 to inform landing mat 110 of the designated date and/or time. Server system 160 may transmit this information to landing mat 110 via a network. The network may include any combination of wired and/or wireless networks, which may include mobile communication networks, Local Area Networks (LANs), Wide Area Networks (WANs), and/or the Internet. For example, landing mat 110 may establish Internet communications with a Wi-Fi router. Server system 160 may then transmit a command to the Wi-Fi router, which may then deliver the date and/or time to landing mat 110 via a wireless Wi-Fi connection. In some embodiments, landing mat 110 may include a SIM card. The SIM card may have been installed and/or inserted into landing mat 110. This may be useful in environments where a Wi-Fi and/or router connection is not available. In this case, server system 160 may deliver the designated date and/or time to landing mat 110 via cellular communications and/or other telephony communications using an identification on the SIM card. In some embodiments, server system 160 may communicate the delivery information to landing mat 110 via satellite communications.

Landing mat 110 may receive and/or store the date and/or time in memory. When operating in low power mode, landing mat 110 may wake and/or activate at an amount of time prior to the specified date and time. Landing mat 110 may operate antennas 130 to transmit LoRa radio signals upon exiting low power mode. While operating in low power mode, landing mat 110 may conserve energy by avoiding the continuous transmission of LoRa radio signals until the specified time of delivery. Landing mat 110 may begin the transmission of LoRa radio signals at a specified time prior to the time of delivery, such as, for example, 30 seconds or a minute prior to delivery. In some embodiments, server system 160 may provide updated times to landing mat 110. The updated times may correspond to a change in delivery time and/or based on delays experienced by aerial drone 140. Landing mat 110 may transmit the LoRA radio signals at the updated times.

Landing mat 110 may cease the transmission of the LoRa radio signals after completion of delivery. In some embodiments, landing mat 110 may use a timer and/or may cease transmission after a particular amount of time has elapsed. For example, landing mat 110 may transmit the LoRa radio signals for 5 minutes. This may be coordinated with the starting transmission time. In some embodiments, landing mat 110 may detect the presence of a package via a camera and/or one or more sensors. Landing mat 110 may receive a signal from aerial drone 140 indicating completion of delivery. Landing mat 110 may cease transmission LoRa radio signals after detection that a package has been delivery.

In some embodiments, landing mat 110 may operate without a low power mode. For example, landing mat 110 may be connected to a wired power source such as a wall outlet. In this case, landing mat 110 may continuously transmit the LoRa radio signals. In some embodiments, landing mat 110 may not receive a date and/or time from server system 160. Instead, a user may manage the date and time of delivery and/or place the mat at or prior to the expected time of delivery.

Returning to server system 160, after determining the date and/or time and the particular landing mat 110 for delivery, server system 160 may transmit this information to base station 170. Server system 160 may transmit the date, time, landing mat 110 identification, and/or geographic coordinate to base station 170 and/or aerial drone 140 via one or more wired and/or wireless networks, which may include mobile communication networks, Local Area Networks (LANs), Wide Area Networks (WANs), and/or the Internet. In some embodiments, base station 170 may be a hub and/or a charging station for aerial drone 140. For example, aerial drone 140 may be housed at base station 170 prior to flight and/or prior to conducting a delivery. Aerial drone 140 may return to base station 170 after completing a delivery. In some embodiments, server system 160 may provide geographic coordinates to aerial drone 140 via base station 170. For example, base station 170 may configure aerial drone 140 to navigate to one or more geographic coordinates. Base station 170 may provide these navigation instructions to aerial drone 140 via a wired and/or a wireless connection with aerial drone 140. In some embodiments, server system 160 may directly provide the navigation instructions to aerial drone 140 without an intermediary base station 170.

In some embodiments, the navigation instructions to direct aerial drone 140 to the geographic coordinate corresponding to landing mat 110 may occur without human intervention. In this manner, server system 160 may autonomously program aerial drone 140 to navigate to landing mat 110 to perform a delivery. In some embodiments, base station 170 may be loaded with a package for the aerial drone 140 to deliver. In some embodiments, aerial drone 140 may be directed to a pick-up waypoint to retrieve a package prior to delivery to landing mat 110. For example, the pick-up waypoint may be another geographic coordinate and/or another landing mat 110 used for picking up a package.

Once aerial drone 140 has been instructed with the geographic coordinate for delivery and/or has been loaded with a package, aerial drone 140 may autonomously travel to the geographic coordinate. This geographic coordinate may correspond to landing mat 110. As aerial drone 140 approaches landing mat 110, aerial drone 140 may detect the LoRa radio signals transmitted from antennas 130 located on landing mat 110. For example, aerial drone 140 may include one or more antennas and/or transceivers. The antennas and/or transceivers may receive and/or process the LoRa radio signals. For example, aerial drone 140 may be configured to detect a particular frequency of radio signals and/or may scan the frequency spectrum and/or a portion of the frequency spectrum to identify frequencies with the highest strength. Aerial drone 140 may then identify different phases corresponding to the LoRa radio signals. Differences in phase detection may correspond to differences in distance traveled by each of the LoRa radio signals. Aerial drone 140 may identify differences in phases as an instruction to re-position. For example, this re-positioning may be performed to align the phases to provide precise positioning. This re-alignment may position aerial drone 140 above landing mat 110 and/or within landing region 150.

Aerial drone 140 may utilize a feedback process to adjust its positioning so that the received LoRa radio signals are detected as having the same phase and/or such that the difference in phases fall within a threshold. In some embodiments, aerial drone 140 may use a trilateration process to perform this positioning. By aligning the phase of the detected LoRa radio signals, aerial drone 140 may precisely position itself above landing mat 110 and/or within landing region 150. When aerial drone 140 is positioned within landing region 150, aerial drone 140 may be centered above landing mat 110. Based on this positioning, aerial drone 140 may be lowered to land on landing mat 110 to provide delivery.

Upon positioning aerial drone 140 to align the phase values, aerial drone 140 may then use a camera located on aerial drone 140 to further aid with precision landing. The camera may capture one or more images and/or video of visual code 120 located on landing mat 110. In some embodiments, visual code 120 may be a design printed on and/or attached to landing mat 110. In some embodiments, visual code 120 may be a dynamic design generated by a display on landing mat 110. The display may be configured to dynamically adjust the dynamic design of visual code 120. The dynamic design of visual code 120 may be within the visible spectrum or may be outside the visible spectrum (e.g., infrared light). The display may be a display screen such as, for example, an active-matrix liquid crystal display (AMLCD), a passive-matrix liquid crystal display (AMLCD), a light-emitting diode (LED) display, a quantum dot light-emitting diode (QLED) display, an organic light-emitting diode (OLED) display, an E Ink electronic paper display (EPD), or the like. The display may be an array of light sources such as, for example, light-emitting diodes, light bulbs, or the like. In some embodiments, visual code 120 may include a matrix code or a QR code. Visual code 120 may include a design and/or may be sized to be detectable by aerial drone 140 at a particular height.

Once aerial drone 140 has positioned itself using the LoRa radio signals, aerial drone 140 may employ image processing and/or computer vision techniques to process visual code 120 to provide additional precise positioning. For example, aerial drone 140 may employ image processing to ensure that visual code 120 is located at a particular position within a captured image. In some embodiments, this may be in the center of the captured image. Aerial drone 140 may use the image processing as an additional feedback mechanism for precise positioning. For example, if aerial drone 140 detects that visual code 120 is not located at the designated position in the image, aerial drone 140 may re-position itself such that a subsequently captured image includes visual code 120 at the designated position. Using the captured images, aerial drone 140 may account for position fluctuations during descent. For example, aerial drone 140 may account for a breeze or other air current that moves aerial drone 140 during descent. Using the captured images, aerial drone 140 may re-position itself to account for such movement.

In some embodiments, aerial drone 140 may switch to using the camera data after positioning using the LoRa radio signals. For example, aerial drone 140 may position itself above landing mat 110 using the LoRa radio signals and then use one or more images of visual code 120 to provide fine-grain control for descent. In some embodiments, the LoRa radio signals may be used together with the images of visual code 120 during descent to provide precise landing. Aerial drone 140 may operate its motors and/or rotors to descend onto landing mat 110.

After descending and/or landing on landing mat 110, aerial drone 140 may release a carried package. For example, the aerial drone 140 may release a clamp, magnet, motorized grip, and/or other mechanism attaching the package to the aerial drone 140. This release may complete a delivery scheduled to the particular geographic coordinate and/or to landing mat 110. In some embodiments, aerial drone 140 may capture an image of the package as delivered on landing mat 110. For example, this image may be used to verify completion of the delivery. In some embodiments, landing mat 110 may include a camera that captures the image of the package. Aerial drone 140 and/or landing mat 110 may transmit the captured image to server system 160 which may be scheduling and/or managing the delivery. Landing mat 110 may perform this transmission via one or more of the previously discussed communication methods. This may include via a Wi-Fi and/or router connection, via cellular communications, and/or via satellite communications.

Server system 160 may receive the captured image to verify completion of the delivery. Server system 160 may store the image in a database and/or update an entry in the database indicating that the delivery has been completed. In some embodiments, server system 160 may also provide a notification to a user requesting the delivery. This notification may be an email, push notification, and/or other type of notification message. The notification may inform the user that the delivery has been completed. In some embodiments, the notification may include a date and/or time of delivery and/or may include one or more images captured by aerial drone 140 and/or landing mat 110. In some embodiments, server system 160 may also track GPS coordinates based on time via the database. The GPS data may track movement of the aerial drone 140 during delivery. Server system 160 may also provide this GPS data to the user to allow tracking of the delivery. This tracking may be performed in real-time during flight of aerial drone 140.

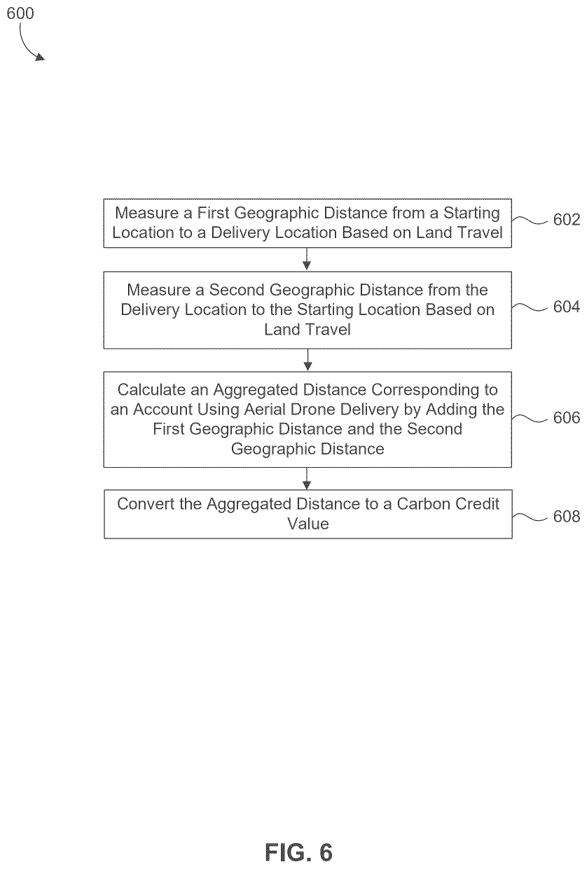

As further described with reference to FIG. 6, server system 160 may also track carbon savings via the use of aerial drone 140 and landing mat 110. For example, if an organization uses a fleet of aerial drones 140 with customers who are using respective landing mats 110 for deliveries, there are carbon savings associated with the avoidance of using land vehicles to make the deliveries. That is, there is a reduction in carbon emissions when aerial drone 140 and landing mat 110 are used for the delivery. Server system 160 managing the aerial drone 140 deliveries may track such savings. For example, server system 160 may track the distance that a truck would have needed to travel to make a delivery and/or return to a delivery hub. In some embodiments, server system 160 may also track the time saved as a reduction in carbon emissions. With these metrics, server system 160 may calculate an amount of carbon emissions saved for a fleet of aerial drones 140 and/or provide such metrics to organizations using the aerial drones 140. For example, the carbon emissions may be calculated based on distance, time, and/or an amount of emissions for a particular distance and time for a delivery truck. The amount of carbon emissions may then be converted to a monetary amount reflecting a monetary amount saved by using aerial drones 140 and/or landing mats 110. In some embodiments, the monetary amount may be reported as a carbon credit value.

FIG. 2 depicts a diagram of a landing mat 200, according to some embodiments. Landing mat 200 may be similar to landing mat 110 as described with reference to FIG. 1. Landing mat 200 may operate in a manner similar to landing mat 110 as described with reference to FIG. 1. Similarly, landing mat 110 may be implemented with the components described with reference to landing mat 200. In some embodiments, landing mat 200 may be implemented using computer system 700 as described with reference to FIG. 7.

Landing mat 200 may include processor 205, memory 210, communication infrastructure 215, visual code 220, transceiver 225, one or more antennas 230, power system 235, camera 240, and/or sensor 245. Processor 205 may include central processing units, CPUs, microprocessors, microcontrollers, and/or other computing systems. Memory 210 may include instructions and/or software which may be executed by processor 205. Processor 205 may execute instructions stored on memory 210 to perform the landing mat functionality described with reference to FIG. 1. Memory 210 may include volatile and/or non-volatile memory. For example, memory 210 may include random access memory (RAM), and/or a removable memory chip (such as an EPROM or PROM). Memory 210 may store control logic (i.e., computer software) and/or data.

Processor 205 may communicate with memory 210 via communication infrastructure 215. Communication infrastructure 215 may provide communication between, for example, processor 205, memory 210, transceiver 225, power system 235, camera 240, and/or sensor 245. In some implementations, the communication infrastructure 215 may be a bus.

Processor 205 may communicate with transceiver 225 and/or antennas 230. Transceivers 225 may generate LoRa radio signals which may be transmitted via antennas 230. In some embodiments, the LoRa radio signals may have the same frequency. As previously explained, aerial drone 140 may use received LoRa radio signals for precise positioning.

Transceiver 225 may include one or more transmitters and/or receivers which transmit and receive communications signals. For example, this may include communication signals communicating with server system 160 and/or aerial drone 140. Signals may be communicated via antennas 230. Antennas 230 may include one or more antennas that may be the same or different types.

The one or more transceivers 225 may include processors, controllers, radios, sockets, plugs, buffers, and like circuits/devices used for connecting to and communication on networks. According to some examples, the one or more transceivers 225 include one or more circuits to connect to and communicate on wired and/or wireless networks. For example, this may include Wi-Fi, cellular, satellite, and/or other networks. In some embodiments, the one or more transceivers 225 may include one or more circuits (including a WLAN transceiver) to enable connection(s) and communication over WLAN networks such as, but not limited to, networks based on standards described in IEEE 802.11. Additionally, or alternatively, the one or more transceivers 225 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 225 may include a Bluetooth™ transceiver.

Landing mat 200 may also include power system 235. Power system 235 may include a battery system. The battery system may utilize replaceable batteries and/or one or more rechargeable batteries. This may aid in portability for landing mat 200. In some embodiments, power system 235 may include a wired power connection. For example, this may allow landing mat 200 to be plugged into a wall outlet. The received power may be used to operate landing mat 200 and/or may be used to recharge a battery. Processor 205 may control power system 235 and/or transceiver 225 to operate in a low power mode as previously described. For example, processor 205 may instruct transceiver 225 to send LoRa radio signals at a particular delivery time using energy stored and/or received ay power system 235.

When a package is delivered, landing mat 200 may use camera 240 and/or one or more sensors 245 to confirm reception of the package. For example, camera 240 may capture one or more images of the package as placed onto landing mat 200. Camera 240 may capture an image at a specified time. In some embodiments, the landing mat may be configured to use image processing to detect completion of delivery. Processor 205 may use transceiver 225 to transmit the image to server system 160 to confirm completion of delivery. In some embodiments, one or more sensors 245 may also confirm reception of the package. For example, sensor 245 may include a weight sensors and/or a line of sight sensor to detect the presence of a package. In some embodiments, aerial drone 140 may transmit a wireless signal to landing mat 200 to signal delivery of the package. Landing mat 200 may capture an image using camera 240 in response to one or more sensors 245 detecting the presence of a package and/or the signal transmitted by aerial drone 140.

Landing mat 200 may also include visual code 220. Visual code 220 may be similar to visual code 120 as described with reference to FIG. 1. In some embodiments, visual code 220 may be a design printed on and/or attached to landing mat 200. In some embodiments, visual code 220 may be a dynamic design generated by a display on landing mat 200. The display may be configured to dynamically adjust the dynamic design of visual code 220. The dynamic design of visual code 220 may be within the visible spectrum or may be outside the visible spectrum (e.g., infrared light). The display may be a display screen such as, for example, an active-matrix liquid crystal display (AMLCD), a passive-matrix liquid crystal display (AMLCD), a light-emitting diode (LED) display, a quantum dot light-emitting diode (QLED) display, an organic light-emitting diode (OLED) display, an E Ink electronic paper display (EPD), or the like. The display may be an array of light sources such as, for example, light-emitting diodes, light bulbs, or the like. In some embodiments, visual code 220 may include a matrix code or a QR code. Visual code 220 may include a design and/or may be sized to be detectable by aerial drone 140 at a particular height.

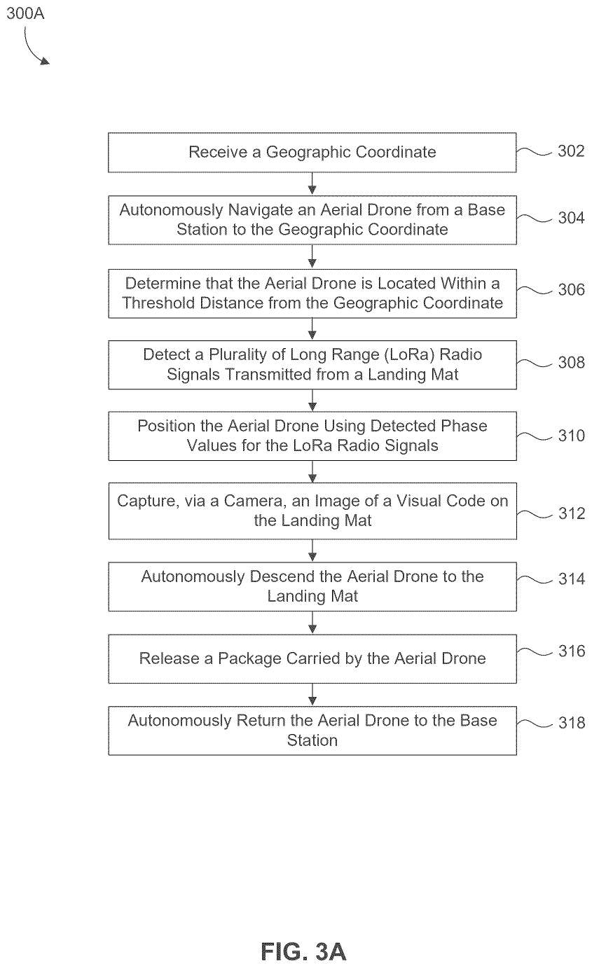

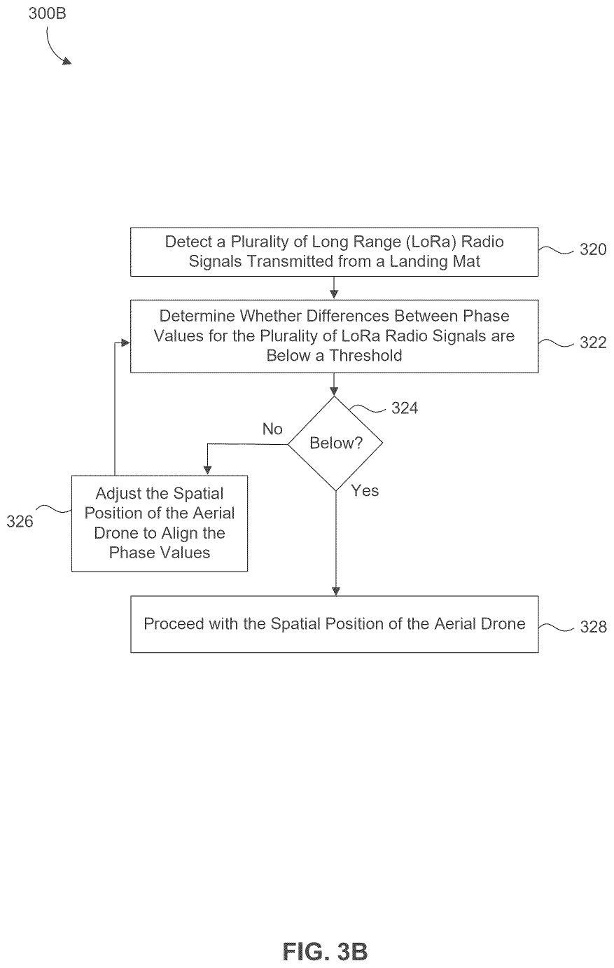

FIG. 3A depicts a flowchart illustrating a method 300A for autonomously operating an aerial drone 140 for delivery, according to some embodiments. Method 300A shall be described with reference to FIG. 1; however, method 300A is not limited to that example embodiment.

In an embodiment, aerial drone 140 may utilize method 300A to autonomously navigate and deliver a package to landing mat 110. The foregoing description will describe an embodiment of the execution of method 300A with respect to aerial drone 140. While method 300A is described with reference to aerial drone 140, method 300A may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3A, as will be understood by a person of ordinary skill in the art.

At 302, aerial drone 140 may receive a geographic coordinate. Aerial drone 140 may receive the geographic coordinate from server system 160 and/or from base station 170. The geographic coordinate may designate a delivery location for delivering a package.

At 304, aerial drone 140 may autonomously navigate from base station 170 to the geographic coordinate. For example, aerial drone 140 may fly from base station 170 to the geographic coordinate. In some embodiments, aerial drone 140 may be instructed by base station 170 and/or server system 160 to begin delivery at a particular date and/or time. Aerial drone 140 may perform the autonomous navigation at this specified date and/or time. In some embodiments, aerial drone 140 may autonomously navigate to the geographic coordinate such that it arrives at the landing mat at a specified date and/or time. In some embodiments, aerial drone 140 may autonomously navigate to the geographic coordinate such that releases a carried package at a specified date and/or time.

At 306, aerial drone 140 may determine that aerial drone 140 is located within a threshold distance from the geographic coordinate. For example, the threshold distance may be 100 feet. Aerial drone 140 may determine this distance based on an internal navigation system. For example, aerial drone 140 may track its own position via a GPS coordinate. Aerial drone 140 may then determine a distance from the geographic coordinate based on its own coordinate. Aerial drone 140 may determine whether the difference between these coordinates is within the threshold distance at 306.

At 308, aerial drone 140 may detect a plurality of long range (LoRa) radio signals transmitted from landing mat 110. Aerial drone 140 may receive the LoRa radio signals for control of its rotors and blades for positioning. For example, aerial drone 140 may include one or more antennas and/or receivers configured to receive the LoRa radio signals. Aerial drone 140 may be configured to detect the LoRa radio signals at particular frequencies. Aerial drone 140 may use one or more low pass filters, high pass filters, and/or bandpass filters and/or sampling techniques to process the LoRa radio signals. Based on this processing, aerial drone 140 may detect and/or extract corresponding phase values for the received LoRa radio signals.

At 310, aerial drone 140 may position itself using the detected phase values corresponding to the LoRa radio signals. In some embodiments, aerial drone 140 may position itself such that the phase values match. For example, aerial drone 140 may detect three LoRa radio signals with three respective phase values: Phase A, Phase B, and Phase C. Aerial drone 140 may position itself such that Phase A equals Phase B and Phase C.

In some embodiments, as further described with reference to FIG. 3B, aerial drone 140 may use a feedback mechanism to adjust its spatial positioning such that that differences between the detected phase values are below a threshold. For example, aerial drone 140 may detect three LoRa radio signals with three respective phase values: Phase A, Phase B, and Phase C. Aerial drone 140 may determine the difference between each of these phase values. For example, there may be a Difference 1 representing the difference between Phase A and Phase B; Difference 2 representing the difference between Phase B and Phase C; and Difference 3 representing the difference between Phase A and Phase C. Aerial drone 140 may position itself such that the Difference 1, Difference 2, and Difference 3 are below a threshold. This may provide tolerances and/or near-matching of phases to position aerial drone 140. Aerial drone 140 may use method 300B as described with reference to FIG. 3B to perform this positioning. In some embodiments, aerial drone 140 may determine the differences between the phases and/or determine whether the phases match to determine its spatial position.

At 312, aerial drone 140 may capture, via a camera on aerial drone 140, an image of visual code 120 on landing mat 110. As previously explained, visual code 120 may be a printed design or a dynamic design displayed on the landing mat. In some embodiments, visual code 120 may include a QR code. Aerial drone 140 may employ image processing and/or computer vision techniques to process visual code 120 to provide additional precise positioning. For example, aerial drone 140 may employ image processing to ensure that visual code 120 is located at a predetermined position within a captured image. In some embodiments, this may be in the center of the captured image. Aerial drone 140 may use the image processing as an additional feedback mechanism for precise positioning. For example, if aerial drone 140 detects that visual code 120 is not located at the predetermined position in the image, aerial drone 140 may re-position itself such that a subsequently captured image includes visual code 120 at the predetermined position. Using the captured images, aerial drone 140 may account for position fluctuations. For example, aerial drone 140 may account for a breeze or other air current that moves aerial drone 140. This may account for the movement prior to and/or during descent. Using the captured images, aerial drone 140 may re-position itself to account for such movement.

Aerial drone 140 may switch to using the camera data after positioning using the LoRa radio signals and/or in conjunction with using the LoRa radio signals. For example, aerial drone 140 may position itself above landing mat 110 using the LoRa radio signals and then use one or more images of visual code 120 to provide fine-grain control for descent. In some embodiments, the LoRa radio signals may be used together with the images of visual code 120 during descent to provide precise landing.

At 314, aerial drone 140 may autonomously descend to landing mat 110. Based on the positioning provided via the LoRa radio signals and/or the camera data, aerial drone 140 may be lowered to land on landing mat 110 to provide delivery. Aerial drone 140 may adjust a spatial position using visual code 120 during descent. In some embodiments, aerial drone 140 may detect that aerial drone 140 and/or the package has touched the landing mat 110 and may cease descent. In some embodiments, aerial drone 140 may hover above landing mat 110 and/or descend to a hovering distance.

At 316, aerial drone 140 may release a package carried by aerial drone 140. For example, the aerial drone 140 may release a clamp, magnet, motorized grip, and/or other mechanism attaching the package to the aerial drone 140. This release may complete a delivery scheduled to the particular geographic coordinate and/or to landing mat 110. In some embodiments, aerial drone 140 may capture an image of the package as delivered on landing mat 110. For example, this image may be used to verify completion of the delivery. Aerial drone 140 may transmit the captured image to server system 160 which may be scheduling and/or managing the delivery. This may occur after aerial drone 140 releases the package and/or after the aerial drone 140 returns to base station 170.

At 318, aerial drone 140 may autonomously return to base station 170. As previously explained, base station 170 be a hub and/or a charging station for aerial drone 140. In some embodiments, aerial drone 140 may autonomously return to a location rather than base station 170. This location may be a location specified prior to delivery.

FIG. 3B depicts a flowchart illustrating a method 300B for adjusting a spatial position of an aerial drone using a detected phase values, according to some embodiments. Method 300B shall be described with reference to FIG. 1; however, method 300B is not limited to that example embodiment.

In an embodiment, aerial drone 140 may utilize method 300B to position itself based on received LoRa signals from landing mat 110. The foregoing description will describe an embodiment of the execution of method 300B with respect to aerial drone 140. While method 300B is described with reference to aerial drone 140, method 300B may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3B, as will be understood by a person of ordinary skill in the art.

At 320, aerial drone 140 may detect a plurality of LoRa radio signals transmitted from landing mat 110. This may occur in the manner described at 308 with reference to FIG. 3A. In some embodiments, aerial drone 140 may use 322, 324, 326, and/or 328 to perform the positioning described at 310 with reference to FIG. 3A.

At 322, aerial drone 140 may determine whether differences between phase values for the plurality of LoRa radio signals are below a threshold. In some embodiments, aerial drone 140 may determine whether the respective phase values match. After extracting the phase values from the received LoRa radio signals, aerial drone 140 may compare the values to determine whether they differ. Aerial drone 140 may determine whether the phase values exactly match and/or whether the difference between the phase values fall below a predefined threshold. In some embodiments, aerial drone 140 may receive three or more LoRa radio signals and/or detected three or more respective phase values. When determining whether the phase values match, aerial drone 140 may compare each of these LoRa radio signals to the others to determine a difference in phase values. Aerial drone 140 may perform this comparison for each of the phase values identified.

At 324, if the differences between the phase values do not fall below the threshold and/or if the phase values do not match, aerial drone 140 may proceed to 326. At 326, aerial drone 140 may adjust its spatial position to align the phase values. Aerial drone 140 may control its positioning to align the received phase for the LoRa radio signals. For example, aerial drone 140 may be configured to adjust its position to decrease a difference between detected phase values. Upon adjusting the spatial position, aerial drone 140 may then return to 322 and 324 to determine whether the phase values match and/or whether the differences fall below the threshold. In this manner, aerial drone 140 may utilize a feedback process to adjust positioning so that the received LoRa radio signals are detected as having the same phase and/or that the differences fall within acceptable tolerances. In some embodiments, aerial drone 140 may use a trilateration process to perform this positioning. By aligning the phase of the detected LoRa radio signals, aerial drone 140 may precisely position itself above landing mat 110. This position may be a desired and/or a centered position above landing mat 110.

Returning to 324, if the differences between the phase values fall below the threshold and/or if the phase values match, aerial drone 140 may proceed to 328. At 328, aerial drone 140 may proceed with the spatial position of aerial drone 140. This spatial position may be the spatial position as adjusted based on the phase values. In some embodiments, using this spatial position, aerial drone 140 may return to 312 as described with reference to FIG. 3A.

In view of methods 300A and 300B, aerial drone 140 may detect a plurality of LoRa radio signals transmitted from landing mat 110. The aerial drone may adjust its spatial position to a first spatial position such that differences between respective phase values for the plurality of LoRa radio signals are below a threshold. In response to the differences between the respective phase values for the plurality of LoRa radio signals being below the threshold, aerial drone 140 may capture, via a camera, a first image of visual code 120 on landing mat 110. Aerial drone 140 may then adjust its spatial position from the first spatial position to a second spatial position such that the visual code 120 appears at a predetermined position in a second image of visual code 120. Aerial drone 140 may then autonomously descend to landing mat 110 from the second spatial position. In response to the descent, aerial drone 140 may then release a package that it is carrying.

During descent, aerial drone 140 may detect movement such that visual code 120 no longer appears at the predetermined position. For example, aerial drone 140 may detect that visual code 120 does not appear at the predetermined position in a third image of visual code 120. In this case, aerial drone 140 may re-adjust its spatial position such that visual code 120 appears at the predetermined position in a fourth image of visual code 120.

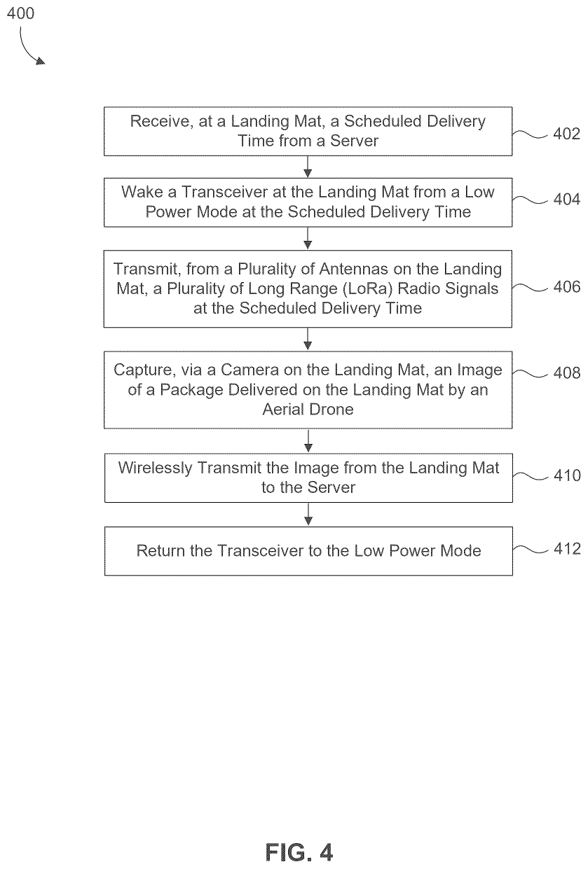

FIG. 4 depicts a flowchart illustrating a method 400 for operating a landing mat 110 for delivery, according to some embodiments. Method 400 shall be described with reference to FIG. 1; however, method 400 is not limited to that example embodiment.

In an embodiment, landing mat 110 may utilize method 400 to provide precise landing for aerial drone 140 for delivering a package to landing mat 110. The foregoing description will describe an embodiment of the execution of method 400 with respect to landing mat 110. While method 400 is described with reference to landing mat 110, method 400 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 402, landing mat 110 may receive a scheduled delivery time from a server. The server may be server system 160 as described with reference to FIG. 1. Landing mat 110 may receive a message and/or instruction from server system 160. For example, server system 160 may schedule a delivery for a particular date and/or time. Server system 160 may then transmit the message and/or instruction to landing mat 110 to inform landing mat 110 of the designated date and/or time. This may include a wired and/or wireless transmission. For example, server system 160 may transmit a command to a residential router which may then deliver the date and/or time to landing mat 110 via a wireless Wi-Fi connection. In some embodiments, landing mat 110 may include a SIM card. This may be useful in environments where a Wi-Fi and/or router connection is not available. In this case, server system 160 may deliver the designated date and/or time to landing mat 110 via cellular communications via the SIM card and/or other telephony communications. In some embodiments, server system 160 may communicate the scheduled delivery time to landing mat 110 via satellite communications.

At 404, landing mat 110 may wake a transceiver from a low power mode at the scheduled delivery time. At 406, landing mat 110 may transmit, from a plurality of antennas 130, a plurality of LoRa radio signals at the scheduled delivery time. In some embodiments, a processor on landing mat 110 may wake the transceiver and/or instruct the transceiver to transmit LoRa radio signals. Landing mat 110 may manage an internal clock and/or calendar application to detect the scheduled delivery time. Landing mat 110 may wake and/or exit the lower power mode at this time and/or before the time of delivery. Landing mat 110 may then transmit the LoRa radio signals used by aerial drone 140 for positioning. In some embodiments, exiting the lower power mode may occur when transmitting LoRa radio signals. In some embodiments, exiting the lower power mode may also include accessing other components of landing mat 110 include a camera, a sensor, and/or a communication interface used to communicate with server system 160.

At 408, landing mat 110 may capture, via a camera on landing mat 110, an image of a package delivered on the landing mat by aerial drone 140. In some embodiments, landing mat 110 may detect the completion of the delivery and/or capture an image of the delivered package. For example, this may be timing based. Landing mat 110 may be configured to capture an image at a specified time. In some embodiments, landing mat 110 may be configured to use image processing to detect completion of delivery. Landing mat 110 may also use a sensor such as a weight sensor and/or a line of sight sensor to detect the presence of a package. In some embodiments, aerial drone 140 may transmit a wireless signal to landing mat 110 to signal delivery of the package. Landing mat 110 may capture an image in response to one or more sensors detecting the presence of a package and/or the signal transmitted by the aerial drone 140.

At 410, landing mat 110 may wirelessly transmit the image to the server, such as server system 160. Landing mat 110 may perform this transmission via one or more of the previously discussed communication methods. This may include via a Wi-Fi and/or router connection, via cellular communications, and/or via satellite communications. Server system 160 may store the image in a database and/or update an entry in the database indicating that the delivery has been completed. In some embodiments, server system 160 may also provide a notification to a user requesting the delivery to inform the user that the delivery has been completed.

At 412, landing mat 110 may return the transceiver to the low power mode. For example, the processor may instruct the transceiver to cease transmission of the LoRa radio signals. In some embodiments, the processor may also de-activate additional landing mat 110 components including a camera, a sensor, and/or a communication interface used to communicate with server system 160. This de-activation may conserve energy at landing mat 110. This may conserve energy when an aerial drone delivery is not expected and/or scheduled.

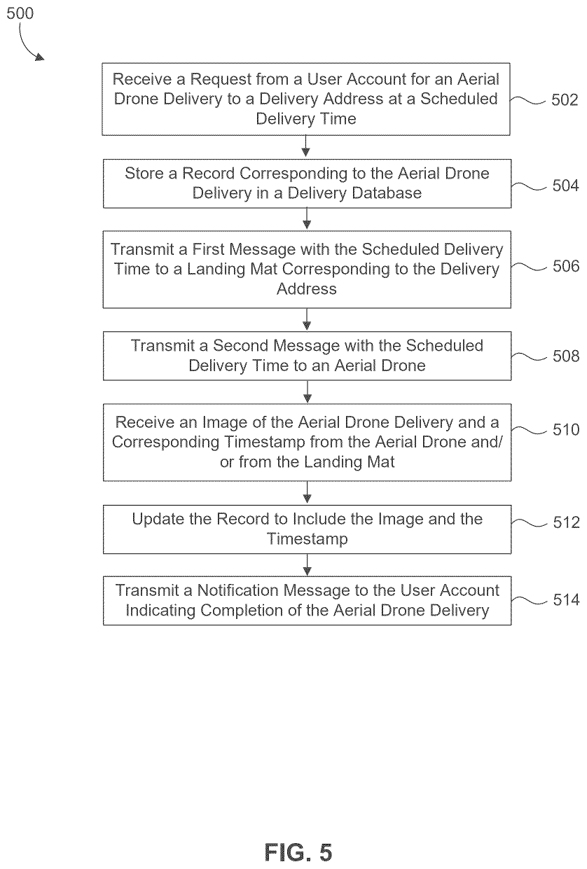

FIG. 5 depicts a flowchart illustrating a method 500 for scheduling an aerial drone delivery, according to some embodiments. Method 500 shall be described with reference to FIG. 1; however, method 500 is not limited to that example embodiment.

In an embodiment, server system 160 may utilize method 500 to schedule autonomous aerial drone delivery to landing mat 110. The foregoing description will describe an embodiment of the execution of method 500 with respect to server system 160. While method 500 is described with reference to server system 160, method 500 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 502, server system 160 may receive a request from a user account for an aerial drone delivery to a delivery address at a scheduled delivery time. As previously explained, server system 160 may manage a fleet of aerial drones 140. Server system 160 may receive a designated aerial drone delivery for a user and/or a corresponding user account. In some embodiments, this delivery may correspond to an online commerce transaction. For example, server system 160 may include and/or may communicate with an online retailer to provide aerial drone delivery services. Server system 160 may receive a delivery address and/or a scheduled delivery time from the online retailer. In some embodiments, server system 160 may determine the scheduled delivery time. For example, the scheduled delivery time may be determined based on fleet availability and/or a previously designated schedule of deliveries. In some embodiments, a user may specify the delivery address and/or the scheduled delivery time. Server system 160 may provide the user with available dates and/or times and the user may provide a selection.

Server system 160 may also determine a geographic coordinate corresponding to the delivery address for the delivery. In some embodiments, a navigation device 165 may be a device embedded within landing mat 110 or an external device coupled to landing mat 110 such that navigation device 165 may automatically obtain a geographic coordinate or an address of landing mat 110 from a satellite service. In these embodiments, navigation device 165 may provide the geographic coordinate or the address of landing mat 110 to server system 160. Navigation device 165 may be an optional component connected to landing mat 110, so some embodiments may not include navigation device 165. In some embodiments, the user and/or online retailer may provide the geographic coordinate. For example, a user may specify an address such as a home or business address for delivery. In some embodiments, the user may specify a GPS coordinate and/or a longitude or latitude coordinate for delivery. In some embodiments, server system 160 may maintain a database of user accounts with corresponding addresses and/or geographic coordinates. The user may select the geographic coordinate corresponding to the user account. In some embodiments, server system 160 may maintain landing mat 110 identifications with corresponding geographic coordinates. For example, the user may provide and/or select a particular landing mat 110 based on its identification. Server system 160 may then identify a geographic coordinate associated with the landing mat 110 identification for the delivery. Server system 160 may use this geographic coordinate as the delivery address.

At 504, server system 160 may store a record corresponding to the aerial drone delivery in a delivery database. The record may correspond to the user account and/or include the delivery address and/or the scheduled delivery time. Server system 160 may identify a particular aerial drone 140 and/or store an aerial drone identification with the record as well.

At 506, server system 160 may transmit a first message with the scheduled delivery time to a landing mat 110 corresponding to the delivery address. For example, server system 160 may track identifications corresponding to multiple landing mats 110. Based on the user account and/or the delivery address, server system 160 may identify a corresponding landing mat 110. Upon identifying the corresponding landing mat 110, server system 160 may transmit the message corresponding to the scheduled delivery time. Landing mat 110 may use the scheduled delivery time to wake from a low power mode as previously explained. In some embodiments, when scheduling an aerial drone delivery, a user may identify the destination delivery address by providing a landing mat 110 identification. Server system 160 may use this identification when transmitting the first message.

At 508, server system 160 may transmit a second message with the scheduled delivery time to an aerial drone 140. Server system 160 may also transmit a geographic coordinate to aerial drone 140 as described at 302 with reference to FIG. 3A. In some embodiments, server system 160 may transmit the scheduled delivery time and/or the geographic coordinate to aerial drone 140 via base station 170. This may instruct aerial drone 140 to navigate to the particular geographic location. In some embodiments, aerial drone 140 may make the decision to begin navigation such that the aerial drone 140 arrives at the landing mat 110 at the scheduled delivery time. In some embodiments, base station 170 may determine the time to instruct aerial drone 140 to begin navigation. Base station 170 may calculate the arrival time based on the departure time such that aerial drone 140 arrives at the scheduled delivery time.

At 510, server system 160 may receive an image of the aerial drone delivery and a corresponding timestamp from aerial drone 140 and/or from landing mat 110. As previously explained, after an aerial drone 140 has arrived and/or delivered the package, aerial drone 140 and/or landing mat 110 may capture an image of the package. This image may capture the package as located on landing mat 110. For example, aerial drone 140 may use a camera to capture an image when hovering above the landing mat 110. In some embodiments, landing mat 110 may include a camera located in a horizontal and/or vertical position which may be angled to capture a packaged placed on or near visual code 120. Aerial drone 140 and/or landing mat 110 may transmit the image to server system 160 to verify completion of delivery. When aerial drone 140 and/or landing mat 110 transmits the image, aerial drone 140 and/or landing mat 110 may also transmit a corresponding timestamp corresponding to the captured image.

At 512, server system 160 may update the record to include the image and the timestamp. Server system 160 may update the record and/or store the image and/or timestamp in the delivery database. In some embodiments, server system 160 may designate the record as a completed delivery in response to receiving the image and/or the timestamp.

At 514, server system 160 may transmit a notification message to the user account indicating completion of the aerial drone delivery. For example, the notification message may be provided to an email address and/or a push notification corresponding to the user account. In some embodiments, server system 160 may inform an online retailer of the completion of the delivery. The online retailer may generate the notification message which is delivered to the user account.

FIG. 6 depicts a flowchart illustrating a method 600 for calculating a carbon credit, according to some embodiments. Method 600 shall be described with reference to FIG. 1; however, method 600 is not limited to that example embodiment.

In an embodiment, server system 160 may utilize method 600 to calculate a carbon credit for a fleet of aerial drones 140 performing autonomous aerial drone delivery to landing mats 110. The foregoing description will describe an embodiment of the execution of method 600 with respect to server system 160. While method 600 is described with reference to server system 160, method 600 may be executed on any computing device, such as, for example, the computer system described with reference to FIG. 7 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 602, server system 160 may measure a first geographic distance from a starting location to a delivery location based on land travel. The first geographic distance may be the distance traveled by a land vehicle to perform the delivery. For example, this may be a route traveled via roads and/or other terrain to deliver the package. This may not be the same distance traveled via an aerial drone 140 because the land travel may present different road and/or traffic routes. In some embodiments, server system 160 may measure the first geographic distance using a mapping application which may account for the roads and/or routes that would be traveled.

At 604, server system 160 may measure a second geographic distance from the delivery location to the starting location based on land travel. The second geographic distance may correspond to a return travel distance that may be traversed by a land vehicle making the delivery. Server system 160 may measure the second geographic distance using a mapping application which may account for the roads and/or routes that would be traveled. In some embodiments, server system 160 may calculate the second geographic distance independent from the first geographic distance. In some embodiments, server system 160 may assume that the second geographic distance is the same as the first geographic distance.

In some embodiments, server system 160 may account for a delivery land vehicle delivering several packages prior to returning to the starting location. For example, the first geographic distance may include one or more delivery locations. This may include the distance traveled as the land vehicle travels between different delivery locations prior to returning to the starting location.

At 606, server system 160 may calculate an aggregated distance corresponding to an account using aerial drone delivery by adding the first geographic distance and the second geographic distance. The aggregated distance may reflect the distance that a land delivery vehicle would have traveled to perform deliveries. Rather than using a land delivery vehicle, the account may have opted to use aerial drone delivery. By using the aerial drone delivery, the account may produce less carbon emissions relative to using a land delivery vehicle. This may be based on the distance that the land delivery vehicle would have traveled as reflected by the aggregated distance.

At 608, server system 160 may convert the aggregated distance to a carbon credit value. For example, sever system 160 may utilize a formula and/or equation that converts the aggregated distance to a carbon credit value. The carbon credit value may reflect an amount of carbon emissions that may have been saved by using aerial drone delivery rather than a land delivery vehicle. For example, the conversion may convert the distance to an amount of carbon emissions. This may depend on a particular vehicle, such as a delivery truck which may be assumed to produce a particular amount of carbon emissions based on distance traveled. In some embodiments, the conversion may also account for an amount of time that the traveled would have taken. Server system 160 may convert the amount of carbon emissions to a monetary amount. The monetary amount may reflect a monetary amount saved by using aerial drones 140 and/or landing mats 110. In some embodiments, the monetary amount may be reported as a carbon credit value.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
detecting, at an aerial drone, a plurality of long range (LoRa) radio signals transmitted from a landing mat;
adjusting, by the aerial drone, a spatial position of the aerial drone to a first spatial position such that differences between respective phase values for the plurality of LoRa radio signals are below a threshold;
capturing, via a camera on the aerial drone, a first image of a visual code on the landing mat responsive to the differences between the respective phase values for the plurality of LoRa radio signals being below the threshold;
adjusting, by the aerial drone, the spatial position of the aerial drone from the first spatial position to a second spatial position such that the visual code appears at a predetermined position in a second image of the visual code;
autonomously descending the aerial drone to the landing mat from the second spatial position; and
releasing, by the aerial drone, a package carried by the aerial drone responsive to the descending.

2. The method of claim 1, further comprising:
autonomously navigating the aerial drone to a geographic coordinate such that the aerial drone arrives at the landing mat at a specified time.

3. The method of claim 1, further comprising:
autonomously navigating the aerial drone to a geographic coordinate such that the aerial drone releases the package at a specified time.

4. The method of claim 1, wherein adjusting the spatial position of the aerial drone to the first spatial position further comprises:
adjusting the spatial position of the aerial drone such that the respective phase values match.

5. The method of claim 1, wherein adjusting the spatial position of the aerial drone to the first spatial position further comprises:
determining that the respective phase values match via a trilateration calculation.

6. The method of claim 1, wherein autonomously descending the aerial drone to the landing mat further comprises:
detecting that the visual code does not appear at the predetermined position in a third image of the visual code; and
re-adjusting the spatial position of the aerial drone during descent such that the visual code appears at the predetermined position in a fourth image of the visual code.

7. The method of claim 1, further comprising:
in response to releasing the package, capturing, via the camera on the aerial drone, an image of the package positioned on the landing mat.

8. A method, comprising:
receiving, at a landing mat, a scheduled delivery time corresponding to an aerial drone delivery;
waking, by the landing mat, a transceiver from a low power mode at the scheduled delivery time;
transmitting, by the transceiver and from a plurality of antennas on the landing mat, a plurality of long range (LoRa) radio signals at the scheduled delivery time;
capturing, via a camera on the landing mat, an image of a package delivered to the landing mat by an aerial drone;
wirelessly transmitting the image from the landing mat to a server managing the aerial drone delivery; and
returning the transceiver to the low power mode.

9. The method of claim 8, wherein receiving the scheduled delivery time further comprises:
establishing, by the landing mat, Internet communications with a Wi-Fi router; and
receiving the scheduled delivery time from the Wi-Fi router.

10. The method of claim 8, wherein receiving the scheduled delivery time further comprises:
establishing, by the landing mat, communications with the server via a cellular communication network; and
receiving the scheduled delivery time from the server via the cellular communication network.

11. The method of claim 10, further comprising:
transmitting, from the landing mat to the server, an identification corresponding to a Subscriber Identification Module (SIM) card installed on the landing mat; and
receiving the scheduled delivery time from the server in response to transmitting the identification corresponding to the SIM card.

12. The method of claim 8, wherein receiving the scheduled delivery time further comprises:
establishing, by the landing mat, communications with the server via a satellite communication network; and
receiving the scheduled delivery time from the server via the satellite communication network.

13. The method of claim 8, further comprising:
recharging a battery on the landing mat.

14. The method of claim 8, wherein capturing the image of the package further comprises:
capturing the image of the package in response to a weight sensor detecting a presence of the package.

15. A landing mat system, comprising:
one or more antennas;
a transceiver coupled to the one or more antennas and to a communication infrastructure;
a camera coupled to the communication infrastructure;
a memory coupled to the communication infrastructure; and
at least one processor coupled to the communication infrastructure and configured to:
receive a scheduled delivery time corresponding to an aerial drone delivery;
wake the transceiver from a low power mode at the scheduled delivery time;
transmit, by the transceiver and from the one or more antennas, a plurality of long range (LoRa) radio signals at the scheduled delivery time;
capture, via the camera, an image of a package delivered by an aerial drone;
wirelessly transmit the image via the transceiver to a server managing the aerial drone delivery; and
return the transceiver to the low power mode.

16. The landing mat system of claim 15, wherein to receive the scheduled delivery time, the at least one processor is further configured to:
establish, via the transceiver, Internet communications with a Wi-Fi router; and
receive, via the transceiver, the scheduled delivery time from the Wi-Fi router.

17. The landing mat system of claim 15, wherein to receive the scheduled delivery time, the at least one processor is further configured to:
establish, via the transceiver, communications with the server via a cellular communication network; and
receive, via the transceiver, the scheduled delivery time from the server via the cellular communication network.

18. The landing mat system of claim 15, further comprising a Subscriber Identification Module (SIM) card and wherein the at least one processor is further configured to:
transmit, via the transceiver to the server, an identification corresponding to the SIM card; and
receive, via the transceiver, the scheduled delivery time from the server in response to transmitting the identification corresponding to the SIM card.

19. The landing mat system of claim 15, wherein to receive the scheduled delivery time, the at least one processor is further configured to:
establish, via the transceiver, communications with the server via a satellite communication network; and
receive, via the transceiver, the scheduled delivery time from the server via the satellite communication network.

20. The landing mat system of claim 15, further comprising a line of sight sensor and wherein to capture the image of the package, the at least one processor is further configured to:
capture the image of the package in response to the line of sight sensor detecting a presence of the package.
